(19) United States
(12) Patent Application Publication
(10) Pub. No.: US 2008/0024494 A1
(43) Pub. Date: Jan. 31, 2008

(54) Method and system for image based rendering large volumetric datasets

(76) Inventors: Perumal Poopathy, Monmouth Junction, NJ (US); Aleksandr Rukodanov, Princeton, NJ (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/525,710

(22) Filed: Sep. 22, 2006

Related U.S. Application Data
(60) Provisional application No. 60/833,119, filed on Jul. 25, 2006.

(51) Int. Cl. G06T 17/00

(52) U.S. Cl. 345/424

(57) ABSTRACT

A method and system are provided for sequential data access in large volumetric data sets with focus on ray casting applications using 32-bit virtual address space.

### PRIORITY CLAIM

This patent application claims priority of U.S. Provisional Patent Application Ser. No. 60/883,119 filed on Jul. 25, 2006. The contents of this provisional patent application is incorporated herein by reference in its entirety.

### BACKGROUND

1. Technical Field

The present disclosure generally relates to the field of data storage. In particular, the present disclosure relates to a method and system for image based rendering large volumetric datasets.

2. Background of Related Art

Currently, two prior art approaches are used for image based rendering large volumetric datasets. The first approach is referred to as the slice-oriented approach and is schematically illustrated by FIG. 1. In this approach, the volumetric dataset consists of a stack of two dimensional slices 100. Each slice 100 is stored in row-by-row order in memory. That is, n+1 row of a slice 100 starts immediately after end of nth row. This approach is a simple way of representing or storing volumes in memory. Most three-dimensional scanners generate and represent raw volumetric data using this approach, especially when the application does not need to perform any data conversion. The disadvantage of this representation is processor cache unfriendly memory access in ray casting (image based rendering).

The second approach is referred to as spatial subdivision approach and is schematically illustrated by FIG. 2. In order to use this approach, the application converts the raw volumetric dataset into sub-volumes 200 of smaller size. The size of the sub-volume 200 is usually chosen that it can fit the processor cache line. The advantage of this approach is in cache-friendly data access in ray casting. The disadvantage of this approach is the need to preprocess the data to computer sophisticated voxel's index calculation and create a copy of the original volume in re-arranged order. Overall, the above two prior art approaches do not solve the problem of handling large volumetric datasets. For example, it is not possible to render and represent a volume in memory that is bigger than two gigabyte size with the above prior art approaches.

Thus, the problem faced in image based rendering (ray casting) of large datasets is in minimizing the amount of paging the operating system performs per rendering of whole volume. Spatial subdivision serves the purpose, but in many cases, several applications need to share access to the same dataset. If some of those applications can only process slice-oriented data (for example, scanner application), the computer memory system needs to keep two copies of the volume. One is a copy of the original volume (slice oriented), and the other copy is subdivided. In case of large volumetric datasets, this is not generally acceptable due to memory constraints.

### SUMMARY

A method and system are provided for sequential data access in large volumetric data sets with focus on ray casting applications using 32-bit virtual address space. In modern medical device world, scanners are producing large volumetric data that enable physicians to visualize and analyze data in more detailed view and quality. But in most of the cases, applications are not able to utilize such large volumetric information due to the fact that large volumes do not fit into application virtual memory address space. The virtual address space of Windows 32bit OS is limited to 2 GB space. Since applications also have some internal data structures, generally a volume size bigger than 1.6 GB is not usable in Win32-bit applications. The present disclosure provides an efficient approach for loading larger volumes into Win32-bit applications.

The approach provided by the present disclosure is referred to as the segmented slice approach. The segmented slice approach can be seen as a compromise approach among the two prior art approaches discussed above. The segmented slice approach while keeping the slice-oriented memory layout, it allows optimizing the memory access pattern and rendering a bigger volume.

The segmented slice approach, apart from solving the problem described in the previous section of image based rendering large volumetric datasets, also provides advantages offered by both slice based and spatial sub-division approaches without requiring creating a copy of the original volume. In the segmented slice approach, volumetric datasets are organized in slices, but each slice is split into multiple segments.

### BRIEF DESCRIPTION OF THE DRAWINGS

FIG. 1 schematically illustrates the slice-oriented approach for image based rendering large volumetric datasets according to the prior art;

FIG. 2 schematically illustrates the spatial subdivision approach for image based rendering large volumetric datasets according to the prior art;

FIG. 3 illustrates a block diagram of a computer system implementing the slice segmented approach in accordance with the present disclosure;

FIG. 4 schematically illustrates the slice segmented approach in accordance with the present disclosure; and

FIGS. 5a and 5b schematically illustrate image based rendering using the slice segmented approach in accordance with the present disclosure.

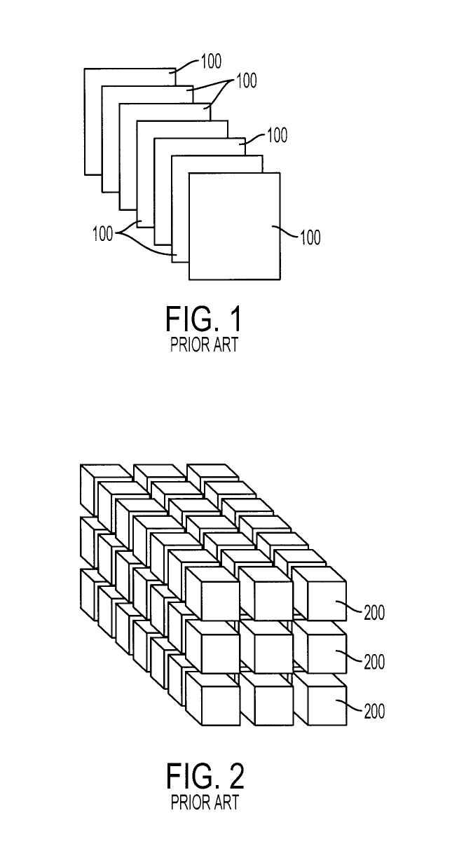

### DETAILED DESCRIPTION

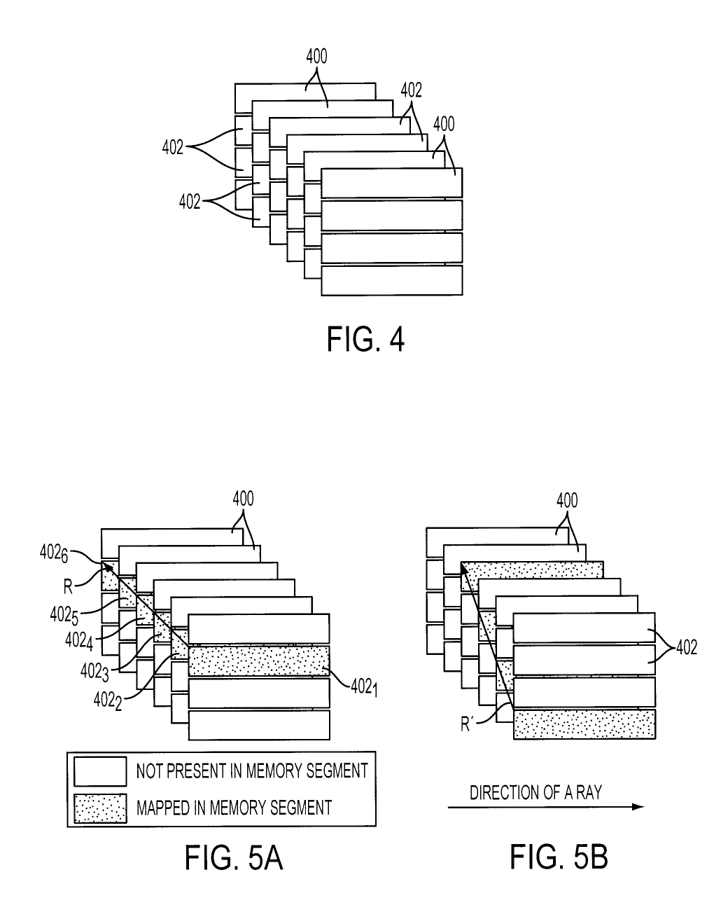

The present disclosure provides an approach referred to as the segmented slice approach for representing large datasets, especially large volumetric datasets representing slices of images. In the segmented slice approach described herein, volumetric datasets are organized in slices 400, where each slice 400 is split into multiple segments 402 (see FIG. 4). The segmented slice approach has elements of both slice-oriented and spatial subdivision approaches.

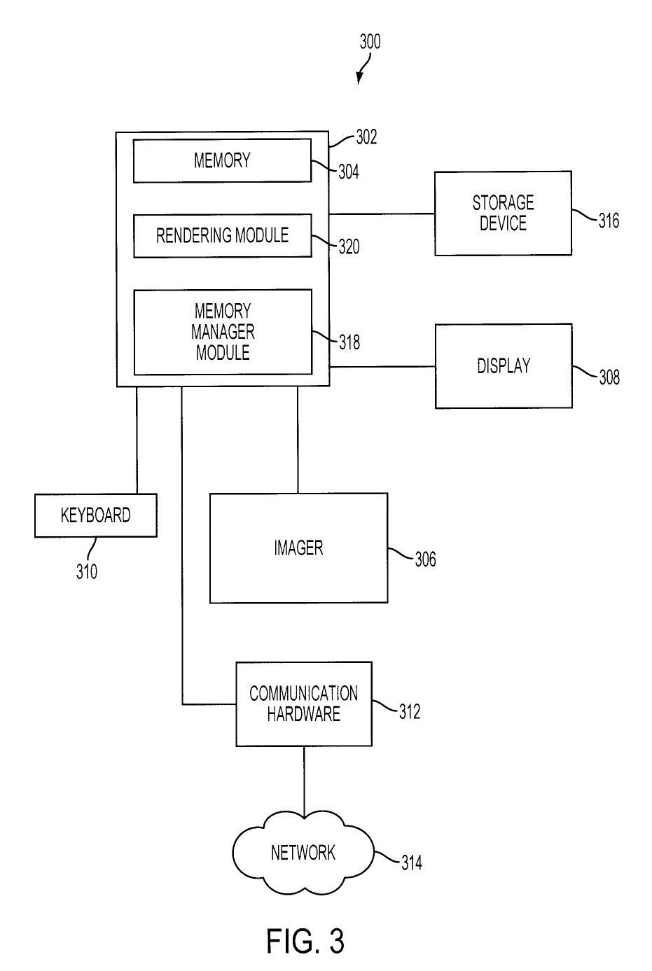

The segmented slice approach is implemented as a set of programmable computer instructions capable of being executed by a processor of a computer system. An exemplary computer system is shown as a block diagram by FIG. 3 and designated generally by reference numeral 300. The computer system 300 includes a processor 302 having memory 304, a digital imager 306, such as an image/text scanner, a display 308, a keyboard 310, communication hardware 312 for communicating via a network 314 with remote computer systems, and at least one storage device 316, such as a hard drive. Other computer systems which can be used for executing the segmented slice approach include MRI, ultrasound imaging, sonar and radar computer systems.

The processor 302 executes the series of computer programmable instructions enabling to perform the segmented slice approach. Accordingly, the computer system 300 is able to render and represent large datasets, especially large volumetric datasets obtained via the network 314, the digital imager 306, or the at least one storage device 316, in memory 304.

The segmented slice approach, as schematically represented by FIG. 4, is particularly useful for transition periods from 32-bit to 64-bit virtual address space. The segmented slice approach solves the problem discussed above by allowing applications to address directly huge amounts of memory while continuing to use 32-bit pointers. In conjunction with Microsoft AWE (Address Windowing Extensions), the segmented slice approach allows applications to have data caches larger than four gigabytes (where sufficient physical memory is present). AWE uses physical non-paged memory and window views of various portions of the physical memory within a 32-bit virtual address space. The size of the segment 402 of a slice 400 is adjusted to the size of the window view of AWE, allowing for particular processor architecture.

A description will now be given which illustrates operation of the segmented slice approach by a computer system, such as computer system 300, for image based rendering of large volumetric data sets. Generally, digital image scanners and other imaging computer systems store each slice of volume data into a single physical file on disk or in memory. The segmented slice approach entails creating one memory mapped buffer for each physical file. Each memory mapped buffer has multiple view segments; that is, each volume slice 400 is split or divided into multiple segments 402. The size of each segment 402 is chosen in such a way that it fits into the processor's cache size.

In order to access an individual voxel, the segment 402 to which the individual voxel belongs to is mapped into process virtual address space and loaded into memory, such as memory 304. During rendering, based on the direction of the initial ray R (see FIG. 5a), segments 402₁₋₆ that are along the path of the ray R are sequentially mapped into process memory. After rendering using the initial ray R, the next ray R′ (FIG. 5b) is picked in such a way that the most voxels from already mapped segments 402₁₋₆ are used.

A memory manager module 318 and a rendering module 320 are provided in the processor 302 for implementing the segmented slice approach. The memory manager module 318 and the rendering module 320 include a series of computer programmable instructions stored in and executed by the processor 302 for performing their respective functions.

The memory manager module 318 manages all memory mapped buffers and keeps track of currently mapped segments. The information from the memory manager module 318 is used by the rendering module 320 in order to select the next ray to be traced. The criterion used by the rendering module 320 in selecting the next ray is to select the ray which has the most voxels along the direction of already mapped (cached) segments 402.

Though the slices 400 are split into multiple segments 402 and only necessary segments are mapped into memory, at some point during execution of the segmented slice approach, it is possible that the entire two gigabyte virtual address space is utilized. To avoid this, the segmented slice approach in accordance with the present disclosure utilizes dynamic locking of segments. That is, each segment is locked into the virtual address space and each locked segment is copied to memory when its respective data is used, and removed or deleted from memory when the segment is no longer needed.

Multiple concepts are used to determine which segments 402 to dynamically unlock or remove from memory, such as the least-recently mapped segments. Hence, by this approach, relatively small portions of volume ends up being completely memory mapped when ray tracing is finished. For large volumes, some file fragments are mapped and unmapped consequently. In this way, at any time, the size of file fragments that are mapped into memory is always less than two gigabytes which is the memory limitation on a 32-bit Windows OS based computer system.

As mentioned above, dynamic mapping of segments 402 enables the rendering of large volumes. But the dynamic mapping and unmapping of a segment multiple times might hinder rendering performance. To overcome performance hindering, “pre-fetching” is employed to map and load the appropriate segment into memory in advance. Based on direction of the ray, the slice segments along the path of the ray are computed and corresponding segments are mapped and loaded into memory in advance. Data “pre-fetching” significantly improves rendering performance.

Currently, there exists no mechanism to render volumetric datasets larger than 1.8 GB on a Win-32bit platform. The present disclosure provides an approach for rendering larger volumetric datasets (greater than 2 GB) on a Win32-bit platform using a processor for executing a series of computer programmable instructions for performing the segmented slice approach according to the present disclosure. The computer programmable instructions can be used for upgrading existing computer systems in order to render large volumetric data sets. Described mechanisms of segmented slices and dynamic loading of pre-fetching allows the overcoming of system limitations on virtual address space and minimizes data paging using Microsoft AWE technology and improves performance of rendering.

Although the present disclosure has been described in accordance with the embodiments shown, one of ordinary skill in the art will readily recognize that there could be variations to the embodiment and these variations would be within the spirit and scope of the present disclosure. Accordingly, many modifications may be made by one of ordinary skill in the art without departing from the spirit and scope of the appended claims.

What is claimed is:

1. A method for image based rendering datasets, said method comprising:
organizing the datasets in a plurality of slices;
splitting each of the plurality of slices into a plurality of segments; and
sequentially mapping a portion of the plurality of segments located along a path of a ray into memory.

2. The method according to claim 1, further comprising selecting a next ray for sequentially mapping another portion of the plurality of segments located along a path of the next ray.

3. The method according to claim 2, wherein the step of selecting the next ray comprises selecting a ray which has the most voxels along the direction of mapped segments.

4. The method according to claim 3, further comprising keeping track of mapped segments for use in selecting the next ray.

5. The method according to claim 1, wherein the step of sequentially mapping comprises pre-fetching at least a segment of the portion of the plurality of segments.

6. The method according to claim 1, further comprising:
locking each mapped segment into a virtual address space;
copying each locked segment to memory when its respective data is used; and
removing the copied segment from memory when the copied segment is no longer needed.

7. The method according to claim 1, wherein the datasets are volumetric datasets representing slices of images.

8. The method according to claim 1, wherein the steps are performed by a computer system using at least a 32-bit virtual address space.

9. In a computer system having a series of computer programmable instructions capable of being executed by a processor of the computer system for performing the method of image based rendering datasets, said method comprising:
organizing the datasets in a plurality of slices;
splitting each of the plurality of slices into a plurality of segments; and
sequentially mapping a portion of the plurality of segments located along a path of a ray into memory.

10. The computer system according to claim 9, the method further comprising selecting a next ray for sequentially mapping another portion of the plurality of segments located along a path of the next ray.

11. The computer system according to claim 10, wherein the step of selecting the next ray comprises selecting a-ray which has the most voxels along the direction of mapped segments.

12. The computer system according to claim 11, the method further comprising keeping track of mapped segments for use in selecting the next ray.

13. The computer system according to claim 9, wherein the step of sequentially mapping comprises pre-fetching at least a segment of the portion of the plurality of segments.

14. The computer system according to claim 9, wherein the method further comprises:
locking each mapped segment into a virtual address space;
copying each locked segment to memory when its respective data is used; and
removing the copied segment from memory when the copied segment is no longer needed.

15. The computer system according to claim 9, wherein the datasets are volumetric datasets representing slices of images.

16. The computer system according to claim 9, wherein the computer system has at least a 32-bit virtual address space.
